(19) United States
(12) Patent Application Publication
(10) Pub. No.: US 2025/0387879 A1
(43) Pub. Date: Dec. 25, 2025

(54) Waterjet Hold-Down Clamp

(71) Applicant: GM GLOBAL TECHNOLOGY OPERATIONS LLC, Detroit, MI (US)

(72) Inventors: David J. PLOZAI, Livonia, MI (US); Melissa Rose GALANT, Clawson, MI (US); Charles Michael DIKOS, Swartz Creek, MI (US)

(21) Appl. No.: 18/750,681

(22) Filed: Jun. 21, 2024

(51) Int. Cl. B25B 5/16; B25B 5/02; B26F 1/26

(52) U.S. Cl. CPC B25B 5/16; B25B 5/02; B26F 1/26

(57) ABSTRACT

A clamp configured to hold a part in a waterjet cutting system, the clamp including: a head including a tip configured to hold the part down onto top surfaces of support slats seated in a water reservoir of the waterjet cutting system; a stem extending from the head, the stem configured to extend through a gap defined between two of the support slats; a base at a distal end of the stem, the base extending perpendicular to the stem and configured to abut bottom surfaces of the support slats; and a lever connected to the stem with a rod in threaded cooperation with the stem such that rotation of the lever screws the rod into the stem pulling the stem into the head. Rotation of the lever draws the base against the bottom surfaces of the support slats and presses the tip against the part.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a clamp configured to hold down a part in a waterjet cutting system.

Waterjet cutting systems include a waterjet configured to cut a part. The waterjet is capable of cutting a wide variety of materials using a high-pressure jet of water, or a mixture of water and an abrasive substance. Waterjet cutting is used in numerous different industries, including the automotive industry.

### SUMMARY

The present disclosure provides for, in various features, a clamp configured to hold a part in a waterjet cutting system, the clamp including: a head including a tip configured to hold the part down onto top surfaces of support slats seated in a water reservoir of the waterjet cutting system; a stem extending from the head, the stem configured to extend through a gap defined between two of the support slats; a base at a distal end of the stem, the base extending perpendicular to the stem and configured to abut bottom surfaces of the support slats; and a lever connected to the stem with a rod in threaded cooperation with the stem such that rotation of the lever screws the rod into the stem pulling the stem into the head. With the stem positioned in the gap defined between the support slats, rotation of the lever draws the base against the bottom surfaces of the support slats and presses the tip against the part to hold the part onto the top surfaces of the support slats.

In further features, the head defines an opening through which the stem extends, cooperation between surfaces of the opening and the stem restricts rotation of the stem relative to the opening.

In further features, the opening and the stem are both rectangular.

In further features, the base includes a first projection at a first end thereof and a second projection at a second end thereof, the stem connects to the base midway between the first end and the second end.

In further features, the base is sized to accommodate two of the support slats between the first projection and the stem and two of the support slats between the second projection and the stem.

In further features, the tip of the head is a first tip, the head further including a second tip opposite to the first tip.

In further features, the first tip and the second tip are different distances away from the stem.

In further features, a first end of the head that is proximate to the first tip is shorter in height than a second end of the head that is proximate to the second tip.

In further features, the lever includes a cammed surface, the lever is rotatable between a raised position and a lowered position about the cammed surface; and rotation of the lever from the raised position to the lowered position pulls the rod and pulls the stem into the head to draw the base closer to the head and reduce a distance between the base and the head.

In further features, the stem is made of a metallic material.

In further features, the head made of a non-metallic material.

In further features, the head is three-dimensionally printed.

In further features, the head extends parallel to the base.

In further features, the lever is on a side of the head opposite to the stem.

The present disclosure further provides for, in various features, a clamp configured to hold a part in a waterjet cutting system, the clamp including: a head configured to hold the part down onto top surfaces of support slats seated in a water reservoir of the waterjet cutting system; a stem extending from the head, the stem configured to extend through a gap defined between two of the support slats; a base at a distal end of the stem configured to abut bottom surfaces of the support slats, the base extending perpendicular to the stem and parallel to the head; and a lever on a side of the head opposite to the stem, the lever connected to the stem with a rod in threaded cooperation with the stem such that rotation of the lever screws the rod into the stem pulling the stem into the head, the lever including a cammed surface and movable about the cammed surface between a raised position and a lowered position. With the stem positioned in the gap defined between the support slats, rotation of the lever draws the base against the bottom surfaces of the support slats and presses the head against the part to hold the part onto the top surfaces of the support slats. Movement of the lever from the raised position to the lowered position pulls the rod and the stem into the head to draw the base closer to the head and reduce a distance between the base and the head.

In further features, the head includes a first tip and a second tip opposite to the first tip; the first tip and the second tip are different distances away from the stem; and a first end of the head that is proximate to the first tip is shorter in height than a second end of the head that is proximate to the second tip.

In further features, the stem is made of a metallic material and the head is made of non-metallic material.

The present disclosure also includes, in various features, a clamp configured to hold a part in a waterjet cutting system, the clamp including: a head configured to hold the part down onto top surfaces of support slats seated in a water reservoir of the waterjet cutting system, the head including a first end and a second end opposite to the first end, the first end is shorter in height than the second end; a stem extending out from within an opening defined by the head, the stem configured to extend through a gap defined between two of the support slats, the stem made of a metallic material; a base at a distal end of the stem configured to abut bottom surfaces of the support slats, the base extending perpendicular to the stem and parallel to the head, the base including projections at opposite ends of the base; and a lever on a side of the head opposite to the stem, the lever connected to the stem with a rod in threaded cooperation with the stem such that rotation of the lever screws the rod into the stem pulling the stem into the head, the lever including a cammed surface and movable about the cammed surface between a raised position and a lowered position. Movement of the lever from the raised position to the lowered position pulls the rod and the stem into the head to draw the base closer to the head and reduce a distance between the base and the head.

In further features, the first end includes a first tip and the second end includes a second tip, the first tip is further from the rod than the second tip.

In further features, the head is made of a non-metallic material.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a waterjet cutting system including clamps in accordance with the present disclosure for holding down a part to be cut by a waterjet;

FIG. 2 is a side view of one of the clamps of FIG. 1;

FIG. 3 is a perspective view of the clamp of FIG. 2;

FIG. 4 illustrates area 4 of FIG. 2;

FIG. 5 is a side view of the clamp of FIG. 2 being inserted between support slats of the waterjet cutting system;

FIG. 6 is a side view of the clamp of FIG. 2 installed in the waterjet cutting system to hold the part; and

FIG. 7 is a side view similar to FIG. 6 with the clamp tightened onto the part relative to FIG. 6.

In the drawings, reference numbers may be reused to identify similar and/or identical elements.

### DETAILED DESCRIPTION

The present disclosure includes a clamp configured to hold down a part in a waterjet cutting system. The system includes a plurality of support slats seated in a water reservoir. The supports slats support the part on top surfaces thereof. The clamp includes a head and a stem extending from the head. The clamp is arranged such that the head contacts the part, and the stem extends down between two of the support slats to bottom surfaces of the slats. The clamp includes a lever, which when twisted draws the stem into the head to tighten the clamp. Specifically, as the lever is twisted a base of the clamp at a distal end of the stem is pulled into cooperation with the bottom surfaces of the slats and the clamp is pushed down onto the part to secure the part in place. By attaching to the bottom surfaces of the slats, the clamp is able to firmly secure the part in place during the waterjet cutting process.

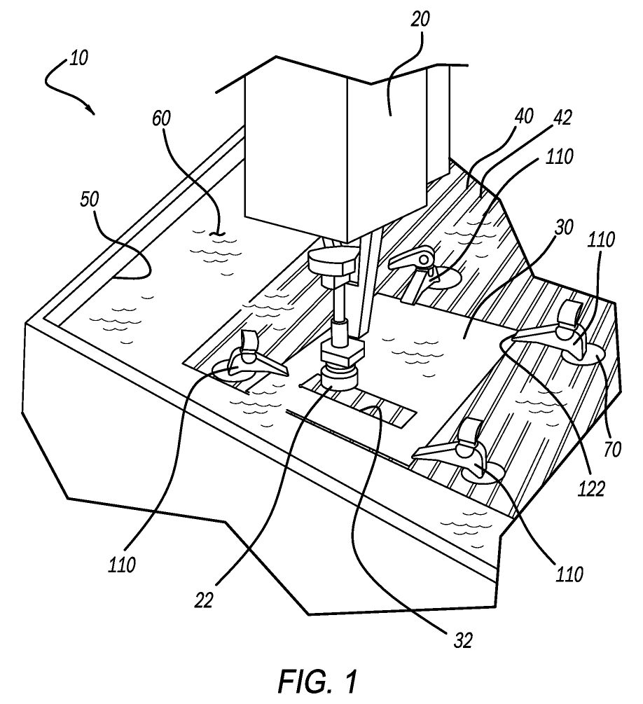

FIG. 1 illustrates a exemplary waterjet cutting system 10 including a waterjet 20. The waterjet 20 may be any suitable waterjet configured to cut a part 30. The waterjet 20 is configured to direct a high-pressure jet of water, or a mixture of water and an abrasive substance, from a nozzle 22 to the part 30 to cut the part 30 in any suitable manner. For example and as illustrated in FIG. 1, the waterjet 20 is configured to cut an opening 32 within the part 30. The part 30 may be any suitable part, such as a part for an automobile or a machine part for a machine used during automotive manufacturing. The waterjet 20, and the waterjet cutting system 10 generally, may be configured for any suitable non-automotive use as well.

The waterjet cutting system 10 further includes a plurality of support slats 40, which are seated in a water reservoir 50. The water reservoir 50 is configured to be filled with water 60. The support slats 40 extend down into the water reservoir. The support slats are spaced apart to define gaps therebetween. The support slats include top surfaces 42 and bottom surfaces 44, which are opposite to the top surfaces 42 (FIGS. 1, 5, 6, and 7).

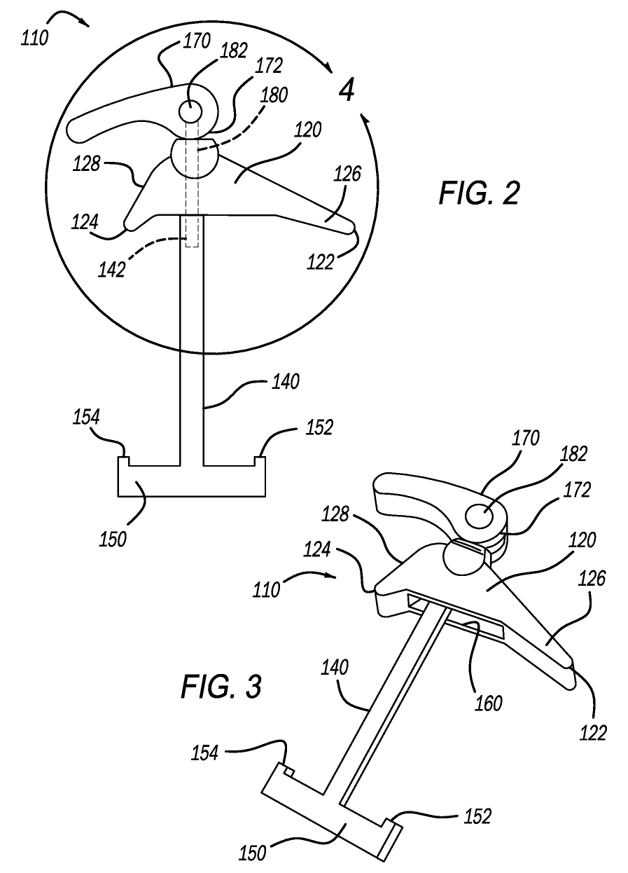

The part 30 is held down onto the top surfaces 42 of the support slats 40 with clamps 110 in accordance with the present disclosure. Any suitable number of the clamps 110 may be used. For example, FIG. 1 illustrates four of the clamps 110 holding the part 30 down onto the plurality of support slats 40. With continued reference to FIG. 1 and additional reference to FIGS. 2-4, each one of the clamps 110 includes a head 120, a stem 140 extending from the head 120, a base 150 at a distal end of the stem 140, and a lever 170.

The head 120 includes a first tip 122 and a second tip 124, which is opposite to the first tip 122. The first tip 122 is at a distal portion of a first end 126 of the head 120. The second tip 124 is at a distal portion of a second end 128. The first end 126 is shorter than the second end 128. The first tip 122 is thus further from a center of the head 120 than the second tip 124. The clamp 110 is configured to be installed in a first orientation in which the first tip 122 contacts the part 30 to hold the part 30 down. FIG. 1 illustrates the first orientation of the claim 110. One or more of the clamps 110 may be rotated generally 180 degrees so that the second tip 124 contacts the part 30 to hold the part 30 down. As explained further herein, the second tip 124 generally applies more downward clamping force onto the part 30 because it is on the shorter second end 128. The first tip 122 may provide less clamping force by being on the longer first end 126. But, because the first end 126 is shorter it will be less likely to obstruct movement of the nozzle 22.

The head 120 may be made of any suitable material. For example, the head 120 may be made of any suitable polymeric material. The head 120 may be formed in any suitable manner, such as by three-dimensional printing.

With particular reference to FIG. 3, the stem 140 extends out from within an opening 160 defined by the head 120. In the example illustrated, the opening 160 is a rectangular opening, and the stem 140 has a rectangular shape, such as in cross-section. Thus, the stem 140 is “keyed” to surfaces of the opening 160 to restrict rotation of the stem 140 relative to the head 120. The stem 140 and the opening 160 may have any other suitable shape or configuration to restrict relative rotation between the head 120 and the stem 140.

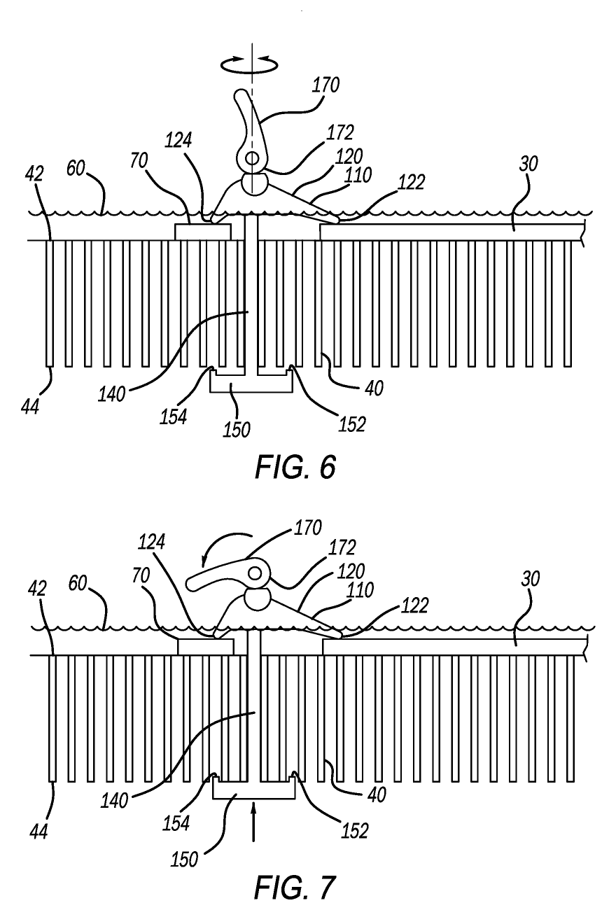

The base 150 is at a distal end of the stem 140. The base 150 extends perpendicular to the stem 140, such that the stem 140 and the base 150 together provide a general “T-shape,” which in the orientation illustrated is an upside-down “T-shape.” The base 150 extends generally parallel to the head 120. The base 150 includes a first projection 152 at a first end and a second projection 154 at a second end. The first projection 152 and the second projection 154 extend towards the head 120. The distance between the first projection 152 and the stem 140 is sufficient to accommodate two of the plurality of support slats 40, as illustrated in FIGS. 5 and 6. Likewise, the distance between the second projection 154 and the stem 140 is sufficient to accommodate two of the plurality of support slats 40. The spacing between the first projection 152 and the stem 140, and between the second projection 154 and the stem 140, may be sized in any other suitable manner to accommodate a single one of the plurality of support slats 40 on opposite sides of the stem 140, or more than two of the plurality of support slats 40.

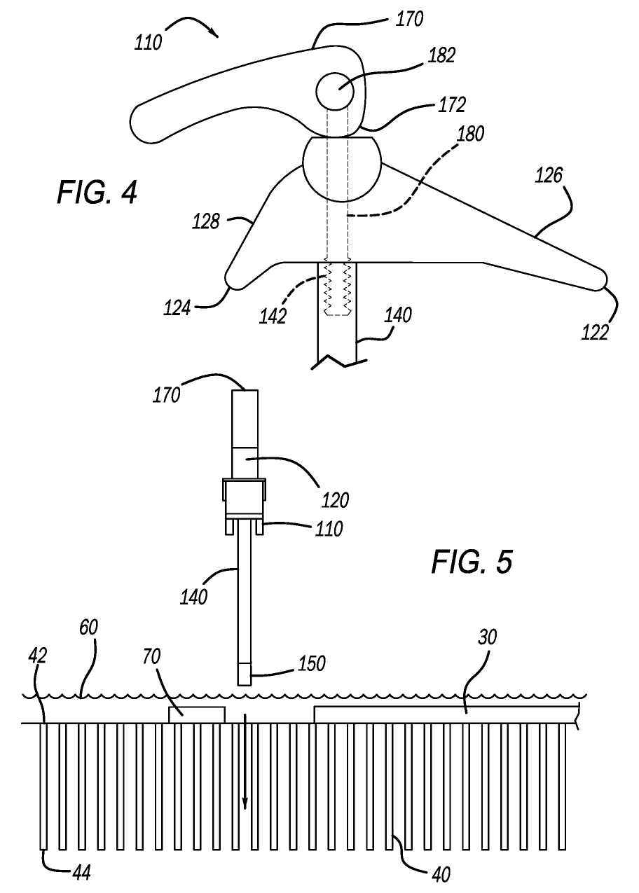

The lever 170 is at a side of the head 120 opposite to the stem 140. The lever 170 is connected to a rod 180, which extends through the head 120 into cooperation with the stem 140. Specifically and with particular reference to FIG. 4, the rod 180 extends into a receptacle 142 defined at a proximal end of the stem 140 opposite to the base 150. Both the rod 180 and the receptacle 142 are threaded.

The lever 170 is rotatable (i.e., twistable) to rotate the rod 180 (see rotation arrows of FIG. 6), and pivotable between a raised position (FIG. 6) and a lowered position (FIG. 7). Rotation of (i.e., twisting of) the lever 170 in a first direction screws the rod 180 into the receptacle 142 of the stem 140 to draw the stem 140 into the head 120 and draw the base 150 closer to the head 120. Rotation of (i.e., twisting of) the lever 170 in a second direction opposite to the first direction unscrews the rod 180 to move the base 150 away from the head 120.

The lever 170 is pivotable about a head 182 of the rod 180 between the raised position of FIG. 6 and the lowered position of FIG. 7. The lever 170 includes a cam surface 172. As the lever 170 is pivoted down from the raised position of FIG. 6 to the lowered position of FIG. 7, cooperation between the cam surface 172 and the head 120 pulls the rod 180 upward and pulls the base 150 into cooperation with the bottom surfaces 44 of the support slats 40 to lock the clamp 110 down onto the part 30 and onto the bottom surfaces 44 of the support slats 40.

With reference to FIGS. 5, 6, and 7, installation of the clamp 110 will now be described further. The clamp 110 is initially positioned as illustrated in FIG. 5 such that the base 150 is parallel to the support slats 40. The base 150 and the stem 140 are then inserted into a gap defined between two of the support slats 40. After the base 150 is beyond the bottom surfaces 44 of the support slats 40, the clamp 110 is rotated so that the base 150 is perpendicular to the support slats 40, as illustrated in FIG. 6. The lever 170 is then rotated/twisted to draw the stem 140 into the head 120, pull the base 150 against the bottom surfaces 44 of the support slats 40, and press the head 120 onto the part 30. Specifically, in the orientation of FIGS. 6 and 7 the first tip 122 is pressed onto the part 30 and the second tip 124 is pressed onto a support pad 70, which is seated on the top surfaces 42 of the support slats 40. After the lever 170 has been rotated/twisted to tighten the clamp 110, the lever 170 is moved from the raised position of FIG. 6 to the lowered position of FIG. 7. Due to the presence of the cam surface 172, as the lever is moved from the raised position to the lowered position, cooperation between the lever 170 and the head 182 of the rod 180 pulls the rod 180 upward and pulls the base 150 against the bottom surfaces 44 of the support slats 40 to further secure the clamp 110 and the part 30 into position. The cam surface 172 restricts rotation of the lever 170 back to the raised position on its own without being moved by an operator of the water jet cutting system 10.

As an alternative to the orientation of FIGS. 6 and 7, the clamp 110 may be rotated 180 degrees so that the second tip 124 presses down on the part 30 and the first tip 122 presses down on the support pad 70. The second tip 124 generally applies more force onto the part 30 because the second tip 124 is closer to the center of the head 120, through which the rod 180 extends. The first tip 122 is further from the center of the head 120, and thus generally provides less downward force. But the first tip 122 is thinner and the first end 126 is generally shorter, which prevents the first end 126 from obstructing movement of the nozzle 22 or other equipment.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A clamp configured to hold a part in a waterjet cutting system, the clamp comprising:
a head including a tip configured to hold the part down onto top surfaces of support slats seated in a water reservoir of the waterjet cutting system;
a stem extending from the head, the stem configured to extend through a gap defined between two of the support slats;
a base at a distal end of the stem, the base extending perpendicular to the stem and configured to abut bottom surfaces of the support slats; and
a lever connected to the stem with a rod in threaded cooperation with the stem such that rotation of the lever screws the rod into the stem pulling the stem into the head,
wherein with the stem positioned in the gap defined between the support slats, rotation of the lever draws the base against the bottom surfaces of the support slats and presses the tip against the part to hold the part onto the top surfaces of the support slats.

2. The clamp of claim 1, wherein the head defines an opening through which the stem extends, cooperation between surfaces of the opening and the stem restricts rotation of the stem relative to the opening.

3. The clamp of claim 2, wherein the opening and the stem are both rectangular.

4. The clamp of claim 1, the base includes a first projection at a first end thereof and a second projection at a second end thereof, the stem connects to the base midway between the first end and the second end.

5. The clamp of claim 4, wherein the base is sized to accommodate two of the support slats between the first projection and the stem and two of the support slats between the second projection and the stem.

6. The clamp of claim 1, wherein the tip of the head is a first tip, the head further including a second tip opposite to the first tip.

7. The clamp of claim 6, wherein the first tip and the second tip are different distances away from the stem.

8. The clamp of claim 7, wherein a first end of the head that is proximate to the first tip is shorter in height than a second end of the head that is proximate to the second tip.

9. The clamp of claim 1, wherein:
the lever includes a cammed surface, the lever is rotatable between a raised position and a lowered position about the cammed surface; and
rotation of the lever from the raised position to the lowered position pulls the rod and pulls the stem into the head to draw the base closer to the head and reduce a distance between the base and the head.

10. The clamp of claim 1, wherein the stem is made of a metallic material.

11. The clamp of claim 10, wherein the head made of a non-metallic material.

12. The clamp of claim 11, wherein the head is three-dimensionally printed.

13. The clamp of claim 1, wherein the head extends parallel to the base.

14. The clamp of claim 1, wherein the lever is on a side of the head opposite to the stem.

15. A clamp configured to hold a part in a waterjet cutting system, the clamp comprising:
a head configured to hold the part down onto top surfaces of support slats seated in a water reservoir of the waterjet cutting system;
a stem extending from the head, the stem configured to extend through a gap defined between two of the support slats;
a base at a distal end of the stem configured to abut bottom surfaces of the support slats, the base extending perpendicular to the stem and parallel to the head; and
a lever on a side of the head opposite to the stem, the lever connected to the stem with a rod in threaded cooperation with the stem such that rotation of the lever screws the rod into the stem pulling the stem into the head, the lever including a cammed surface and movable about the cammed surface between a raised position and a lowered position,
wherein:
with the stem positioned in the gap defined between the support slats, rotation of the lever draws the base against the bottom surfaces of the support slats and presses the head against the part to hold the part onto the top surfaces of the support slats; and
movement of the lever from the raised position to the lowered position pulls the rod and the stem into the head to draw the base closer to the head and reduce a distance between the base and the head.

16. The clamp of claim 15, wherein:
the head includes a first tip and a second tip opposite to the first tip;
the first tip and the second tip are different distances away from the stem; and
a first end of the head that is proximate to the first tip is shorter in height than a second end of the head that is proximate to the second tip.

17. The clamp of claim 15, wherein the stem is made of a metallic material and the head is made of non-metallic material.

18. A clamp configured to hold a part in a waterjet cutting system, the clamp comprising:
a head configured to hold the part down onto top surfaces of support slats seated in a water reservoir of the waterjet cutting system, the head including a first end and a second end opposite to the first end, the first end is shorter in height than the second end;
a stem extending out from within an opening defined by the head, the stem configured to extend through a gap defined between two of the support slats, the stem made of a metallic material;
a base at a distal end of the stem configured to abut bottom surfaces of the support slats, the base extending perpendicular to the stem and parallel to the head, the base including projections at opposite ends of the base; and
a lever on a side of the head opposite to the stem, the lever connected to the stem with a rod in threaded cooperation with the stem such that rotation of the lever screws the rod into the stem pulling the stem into the head, the lever including a cammed surface and movable about the cammed surface between a raised position and a lowered position,
wherein movement of the lever from the raised position to the lowered position pulls the rod and the stem into the head to draw the base closer to the head and reduce a distance between the base and the head.

19. The clamp of claim 18, wherein the first end includes a first tip and the second end includes a second tip, the first tip is further from the rod than the second tip.

20. The clamp of claim 18, wherein the head is made of a non-metallic material.
